(19) United States
(12) Patent Application Publication
(10) Pub. No.: US 2009/0319066 A1
(43) Pub. Date: Dec. 24, 2009

(54) AUDIO REPRODUCING APPARATUS

(75) Inventors: Masayuki TSUJI, Tokyo (JP); Noboru Yashima, Tokyo (JP); Fumio Abe, Tokyo (JP); Isao Otsuka, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 12/480,244

(22) Filed: Jun. 8, 2009

(30) Foreign Application Priority Data
Jun. 9, 2008 (JP) 2008-150542
Oct. 30, 2008 (JP) 2008-279816

(51) Int. Cl. G06F 17/00; G06F 17/10

(52) U.S. Cl. 700/94; 708/322

(57) ABSTRACT

An audio reproducing apparatus has a correction coefficient holding means (6) for holding at least one set of correction coefficients (K0) based on an inverse characteristic (H0) of a transfer characteristic from a speaker means (10) to a listening position (13). The correction coefficients are derived by convolution of an arbitrary transfer characteristic (H00) and the inverse characteristic (H0). The correction coefficients (K0) held by the correction coefficient holding means (6) are convolved with the audio signal in the non-recursive digital filter means (5) to generate output. The audio reproducing apparatus can realize an arbitrary acoustic characteristic easily, with a simple structure. Not just high fidelity audio reproduction, but also recreation of intended sound quality is enabled.

### BACKGROUND OF THE INVENTION

1. Field of the Invention

The present invention relates to an audio reproducing apparatus that performs an inverse correction with respect to the transfer characteristic from the speaker to the listening position to improve reproduction characteristics so as to recreate the original audio signal faithfully, and can then add an arbitrary sound quality characteristic.

2. Description of the Related Art

In audio reproducing systems for various types of AV equipment, such as television sets, there have been various factors that prevent faithful reproduction of the original audio signal. If the front structure of the speaker includes a sound duct and speaker grille, for example, high frequency attenuation and the occurrence of peaks and dips caused by acoustic resonance in the sound duct impair fidelity and degrade sound quality. The environment in which the audio reproducing system is placed may also become a fidelity-reducing factor. Examples include cases in which there are dominant reflected waves comparable to the direct wave and cases in which there are objects (human bodies) that attenuate sound waves.

Various attempts have therefore been made to correct the transfer characteristic from the speaker to the listening position by using digital filters, more specifically to flatten the sound pressure and group delay characteristics of the speaker system, including the transfer space, to achieve a sound quality faithful to the original audio signal. In Japanese Patent Application Publication No. S58-50812, cited as prior art in Japanese Patent Application Publication No. H8-228396, a correction based on a transfer characteristic corresponding to the inverse characteristic of the frequency-amplitude characteristic from the speaker to the listening position is carried out by use of non-recursive digital filter operations, whereby the sound pressure-frequency characteristic at the listening position is corrected. In Japanese Patent Application Publication No. H8-228396, the audio reproducing apparatus is configured so that the effect of the reproduction characteristic of the speaker unit itself can be eliminated by an inverse correction of the transfer characteristic from the sound duct at the front of the speaker to the listening position, thereby facilitating adaptation to changes in unit type. Japanese Patent Application Publication No. H8-228396 also shows an audio reproducing apparatus that automates the generation of a transfer characteristic corresponding to the inverse characteristic of the frequency-amplitude characteristic from the speaker to the listening position.

The above conventional audio reproducing apparatuses make corrections by convolving a transfer characteristic corresponding to the inverse characteristic of the frequency-amplitude characteristic from the speaker to the listening position with the original audio signal by use of a non-recursive digital filter. If an inverse characteristic filter capable of implementing a correction with an ideal transfer characteristic of 1 can thereby be created, then the result of audio reproduction will be that output faithful to the input signal is obtained. This high-fidelity output, however, does not always have the preferred sound quality. For example, inspection of the transfer characteristics of so-called high sound quality speakers shows that they include specific reverberation components which could be called their characterizing features, and inspection of their frequency characteristics shows an appropriate amount of high frequency roll-off, as well as low-frequency roll-off due to constraints on their lowest resonant frequency.

It is furthermore difficult to implement an inverse characteristic filter that makes faithful corrections. Its peaks and dips are determined by the finite number of taps constituting the non-recursive digital filter; if they occur in frequency regions offset from the frequencies of the frequency groups that are controllable by the filter coefficients, faithful correction is particularly difficult.

The above conventional audio reproducing apparatuses provide examples in which the transfer characteristic corresponding to the inverse characteristic of the frequency-amplitude characteristic from the speaker to the listening position can be automatically generated in actual usage environments, but performing actual measurements and generating inverse characteristics in actual usage environments leads to a complex circuit configuration and increased circuit size. Moreover, the other side of the capability to perform corrections matched to the usage position and ambient environment is that users of general consumer equipment such as television sets are left to perform measurement/generating operations, so whether optimal correction is achieved remains doubtful.

### SUMMARY OF THE INVENTION

An object of the present invention is to provide an audio reproducing apparatus that, although simple in structure, can implement arbitrary acoustic characteristics.

Another object of the present invention is not just to enable high fidelity audio reproduction but to enable recreation of the intended sound quality.

An audio reproducing apparatus according to the invention supplies an audio signal that has been corrected by a non-recursive digital filter means to a speaker means, thereby producing acoustic radiation, and includes:

a correction coefficient holding means for holding at least one set of correction coefficients based on an inverse characteristic of a transfer characteristic from the speaker means to a listening position,

and is characterized in that

the correction coefficients are calculated by convolution of an arbitrary transfer characteristic and the inverse characteristic; and

the correction coefficients held by the correction coefficient holding means are convolved with the audio signal in the non-recursive digital filter means to generate output.

The present invention has the effect of enabling not just high fidelity audio reproduction but reproduction of the intended sound quality.

### BRIEF DESCRIPTION OF THE DRAWINGS

In the attached drawings:

FIG. 1 is a block diagram illustrating the basic structure of an apparatus according to a first embodiment of the invention;

FIG. 2 is a drawing showing an example of the reproduction characteristic of the audio reproducing apparatus in the first embodiment of the invention;

FIG. 3 is a drawing showing an example of the inverse characteristic of the audio reproducing apparatus in the first embodiment of the invention;

FIG. 4 is a drawing showing an example of the listening characteristic of the audio reproducing apparatus in the first embodiment of the invention;

FIGS. 5(a) to 5(c) are drawings illustrating one exemplary simplified acoustic radiation characteristic used to describe the operation of the audio reproducing apparatus in the first embodiment of the invention;

FIGS. 6(a) to 6(c) are drawings illustrating another exemplary simplified acoustic radiation characteristic used to describe the operation of the audio reproducing apparatus in the first embodiment of the invention;

FIGS. 7(a) to 7(c) are drawings illustrating an improvement of the characteristics in FIGS. 5(a) to 5(c), used to describe the operation of the audio reproducing apparatus in the first embodiment of the invention;

FIG. 8 illustrates an exemplary structure of the recursive digital filter means 2 in the apparatus according to the first embodiment of the invention;

FIG. 9 is a drawing illustrating an exemplary peaking filter characteristic due to the recursive digital filter means 2 in the apparatus according to the first embodiment of the invention;

FIGS. 10(a) to 10(c) are drawings illustrating an improvement of the characteristics in FIGS. 6(a) to 6(c), used to describe the operation of the audio reproducing apparatus in the first embodiment of the invention;

FIG. 11(a) is a block diagram illustrating a structure for deriving the inverse characteristic in the apparatus according to the first embodiment of the invention; FIGS. 11(b) and 11(c) are waveform diagrams illustrating its operation;

FIG. 12 is a drawing illustrating an exemplary structure of the non-recursive digital filter means 5 in the apparatus according to the first embodiment of the invention;

FIGS. 13(a) and 13(b) are drawings, related to the description of the first embodiment of the invention, illustrating results of measurements of uncorrected transfer characteristics of an existing speaker with inadequate performance;

FIGS. 14(a) and 14(b) are drawings, related to the description of the first embodiment of the invention, illustrating inverse characteristics to the uncorrected transfer characteristics of the existing speaker with inadequate performance;

FIGS. 15(a) and 15(b) are drawings, related to the description of the first embodiment of the invention, illustrating the corrected transfer characteristics of the existing speaker with inadequate performance;

FIGS. 16(a) and 16(b) are drawings, related to the description of the first embodiment of the invention, illustrating exemplary acoustic characteristics of a high sound quality speaker;

FIGS. 17(a) to 17(c) are drawings, related to the description of the first embodiment of the invention, illustrating a reverberation characteristic; and

FIG. 18 is a block diagram illustrating the basic structure of an apparatus according to a second embodiment of the invention.

### DETAILED DESCRIPTION OF THE INVENTION

Embodiments of the invention will be described below with reference to the drawings.

### First Embodiment

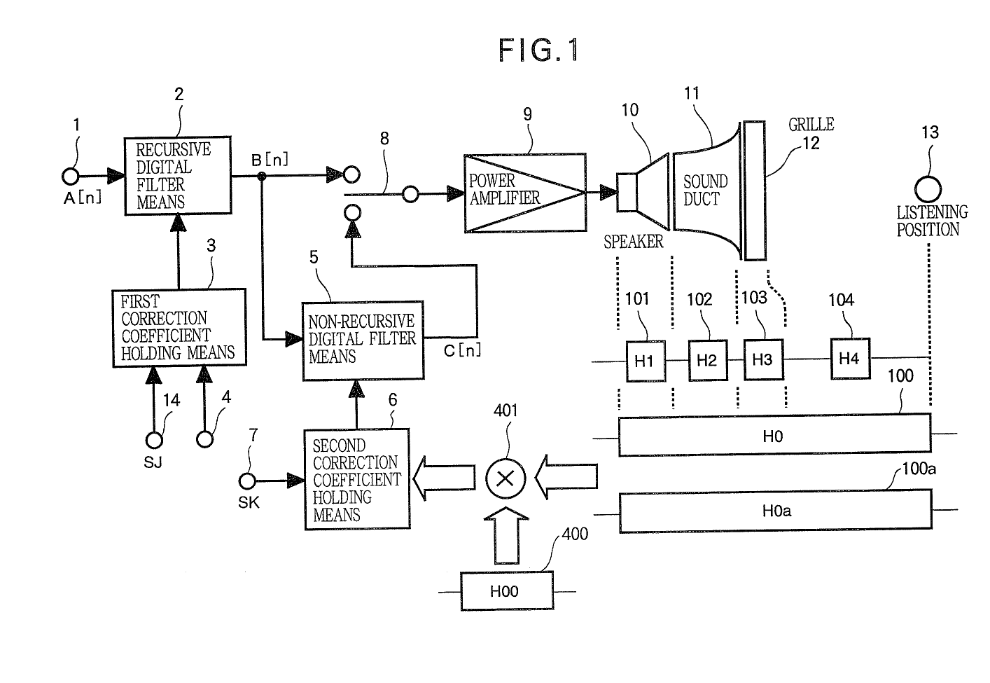

FIG. 1 is a block diagram illustrating the basic structure of an audio reproducing apparatus according to the first embodiment of the invention. The audio reproducing apparatus shown has an audio signal input terminal 1, a recursive digital filter means 2, a first correction coefficient holding means 3, a first correction coefficient input terminal 4, a non-recursive digital filter means 5, a second correction coefficient holding means 6, a second correction coefficient selection terminal 7, a switching selection means 8, a power amplifier 9, a speaker 10, a sound duct 11, and a speaker grille 12.

As an example, in a television set, the speaker grille 12 is a porous acoustic resistance element forming the face of the front panel speaker; the sound duct 11 is a molded plastic part that connects the front edge of the speaker 10 to the back surface of the speaker grille 12, forming a front chamber with a constant volume between the speaker 10 and speaker grille 12.

The recursive digital filter means 2 corrects or changes the transfer characteristic of an audio signal A[n] applied to the audio signal input terminal 1.

The first correction coefficient holding means 3 holds a plurality of sets of coefficients and outputs appropriate coefficients to the recursive digital filter means 2.

The first correction coefficient input terminal 4 is used to input filter coefficients to the first correction coefficient holding means 3.

The first correction coefficient selection terminal 14 is used to input a selection signal SJ to select one of the sets of coefficients held in the first correction coefficient holding means 3.

The non-recursive digital filter means 5 corrects or changes the transfer characteristic of an audio signal B[n] output from the recursive digital filter means 2.

The second correction coefficient holding means 6 holds a plurality of sets of coefficients and outputs appropriate coefficients to the non-recursive digital filter means 5.

The second correction coefficient selection terminal 7 is used to input a selection signal SK to select one of the sets of coefficients held in the second correction coefficient holding means 6.

The switching selection means 8 switches between the audio signal B[n] output from the recursive digital filter means 2 and an audio signal C[n] output from the non-recursive digital filter means 5, thereby selecting and outputting one of them.

A computational block 400 outputs a transfer function H00 having an arbitrary desired characteristic. A convolver 401 convolves the transfer function H00 supplied from computational block 400 with a transfer function H0 or H0a supplied from a computational block 100 or 100a and generates filter coefficients KO based on the transfer function obtained as the result of convolution.

Computational block 400, computational blocks 100 and 10a, and the convolver 401 are not components of the audio reproducing apparatus but are used at the stage at which the coefficients KO in the audio reproducing apparatus are generated.

Among them, computational block 100 outputs the inverse characteristic H0 of the combined frequency-amplitude characteristic from the speaker 10 to the listening position 13.

Computational block 100 can be represented as a combination of computational blocks 101 to 104. The transfer function H1 of computational block 101 is equivalent to the inverse characteristic of the frequency-amplitude characteristic of the speaker 10 taken alone; the transfer function H2 of computational block 102 is equivalent to the inverse characteristic H2 of the frequency-amplitude characteristic of the sound duct 11 taken alone; the transfer function H3 of computational block 103 is equivalent to the inverse characteristic of the frequency-amplitude characteristic of the speaker grille 12 taken alone; the transfer function H4 of computational block 104 is equivalent to the inverse characteristic H4 of the frequency-amplitude characteristic of the acoustic space from the output end of speaker grille 12 to the listening position 13, taken alone.

Like transfer function H0, the transfer function H0a output from computational block 100a is equivalent to the inverse characteristic of the combined frequency-amplitude characteristic from the speaker 10 to the listening position 13, but it is a characteristic analogous to transfer function H0, with the characteristic change due to the recursive digital filter means 2 taken into account.

Transfer functions H0 and H0a are obtained as described below.

In the audio reproducing apparatus in FIG. 1, two sets of convolved correction coefficients are held in the second correction coefficient holding means 6, one set being obtained as a result of convolution of the correction coefficients based on transfer function H0 with transfer function H00, the other set being obtained as a result of convolution of the correction coefficients based on transfer function H0a with transfer function H00, and the two sets of convolved correction coefficients are switched in accordance with the selection signal SK input from the second correction coefficient selection terminal 7 to change the audio signal transfer characteristic in the non-recursive digital filter means 5.

The second correction coefficient holding means 6 may hold three or more sets of correction coefficients (obtained by convolution with transfer function H00), and one of the sets may be selected in accordance with the selection signal SK. In that case, the characteristic of transfer function H00 may be changed to generate a plurality of correction coefficients.

Next the operation of the audio reproducing apparatus structured as shown in FIG. 1 will be described.

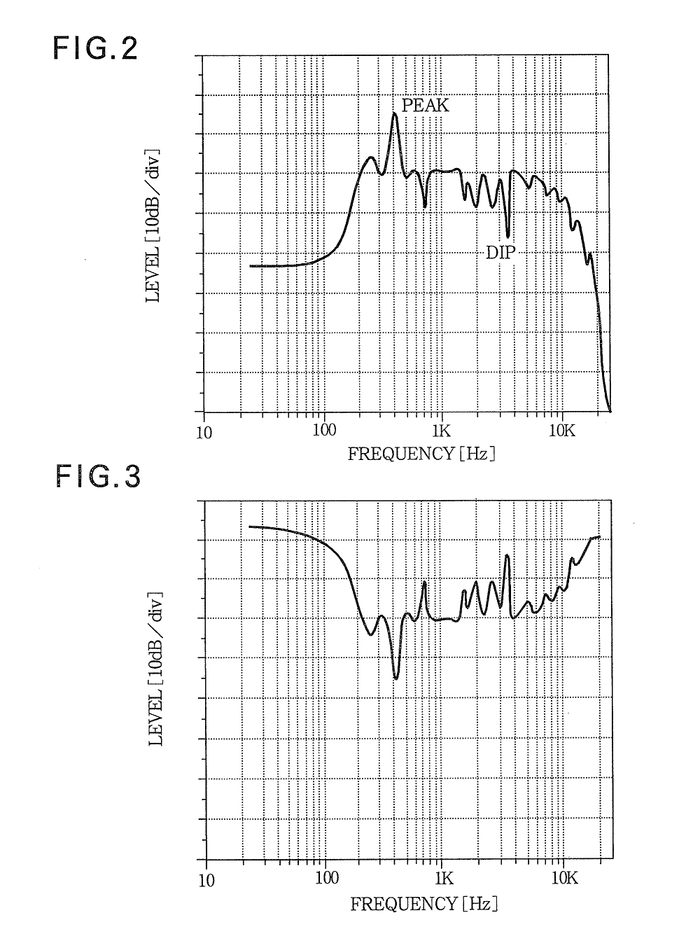

FIG. 2 is an example of the reproduction characteristic of an audio reproducing apparatus using the speaker 10 as an electro-acoustic transducer, showing the acoustic radiation characteristic from the speaker 10 to the listening position 13, including the sound duct 11 and the speaker grille 12. The acoustic radiation characteristic at the listening position 13 is obtained in the structure shown in FIG. 1 when the transfer characteristic of the recursive digital filter means 2 is 1, and the switching selection means 8 selects the recursive digital filter means 2, or when the combined transfer characteristic of the recursive digital filter means 2 and the non-recursive digital filter means 5 is 1, and the switching selection means 8 selects the non-recursive digital filter means 5.

FIG. 3 is a drawing illustrating the inverse characteristic of the acoustic radiation characteristic at the listening position 13 shown in FIG. 1.

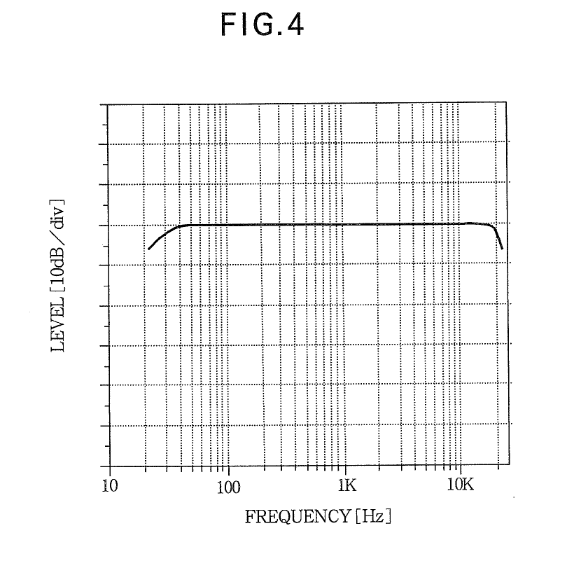

FIG. 4 is a drawing showing an example of the listening characteristic when the audio reproducing apparatus structured as shown in FIG. 1 reproduces an audio signal by using correction coefficients based on the inverse characteristic shown in FIG. 3.

In other words, FIG. 4 shows the listening characteristic at the listening position 13 when an audio signal is reproduced by the structure shown in FIG. 1 if the transfer characteristic of the non-recursive digital filter means 5 is varied (adjusted so that the transfer characteristic of the non-recursive digital filter means 5 is H0) by using the correction coefficients of the computational block 100 having the transfer characteristic H0 shown in FIG. 3, that is, by using the output of the convolver 401 when the transfer characteristic of the computational block 400 having transfer function H00 is 1. The amount of correction is limited with respect to the reproduction capability of the speaker; the actual characteristic shows low-frequency and high-frequency roll-off, for example.

In the examples in FIGS. 2 to 4, an ideal inverse characteristic is obtained and an ideal correction is made, but in practice it is impossible to extend the taps of the non-recursive digital filter means 5 to the ideal length, because of constraints on circuit size or constraints on processing delay. Accordingly, there are discrete frequency points (referred to below as correctable points) determined by the finite number of taps constituting the non-recursive digital filter means 5 where amplitude control is possible by the filter coefficients, and the peaks and dips in the acoustic radiation characteristic shown in FIG. 2 (that is, the transfer characteristic from the speaker 10 to the listening position 13 in FIG. 1) do not necessarily coincide with these correctable points. For example, with 48-kHz sampling, if a non-recursive digital filter is configured with 256 taps, the correctable points occur at intervals of 187.5 Hz.

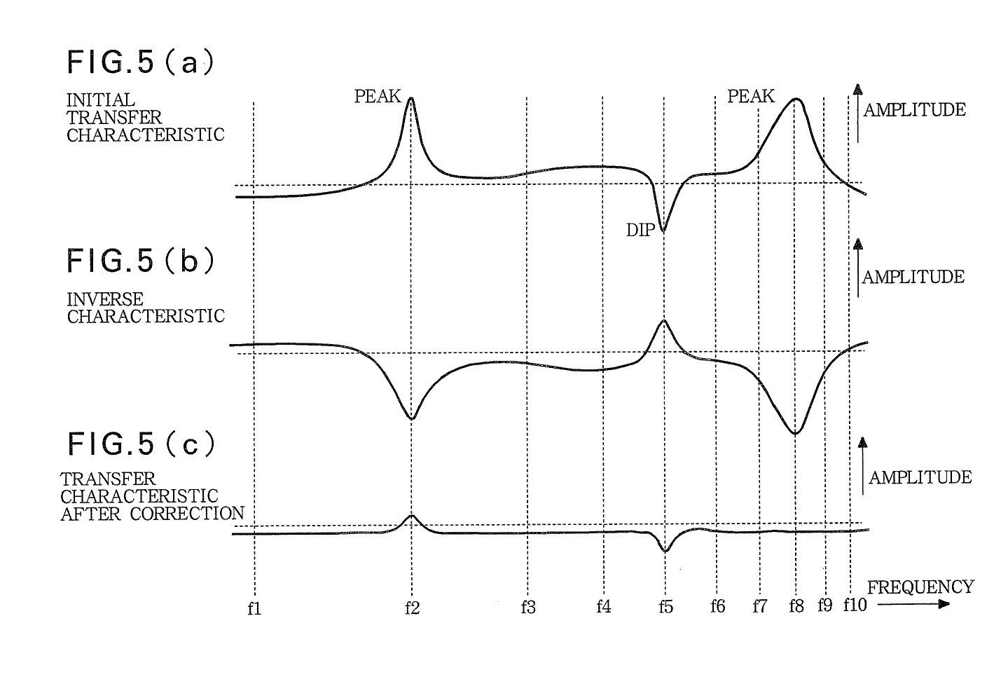

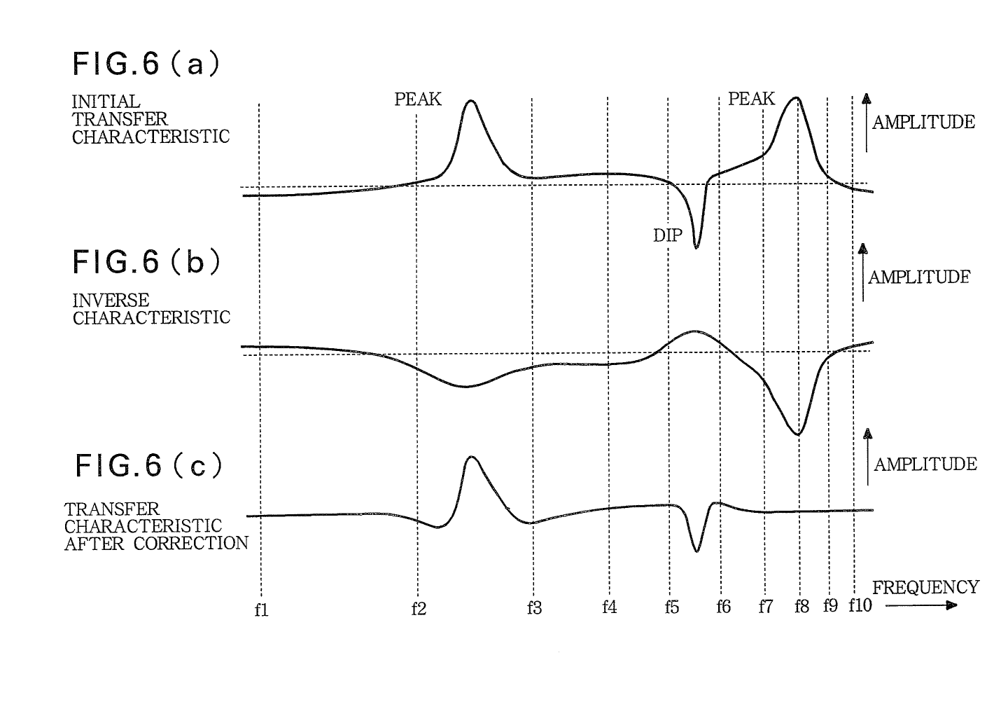

For purposes of illustration, FIGS. 5(a) to 5(c) and FIGS. 6(a) to 6(c) show enlarged examples of simplified acoustic radiation characteristics at the listening position 13, with peaks and dips present at just a few locations in the characteristics. In FIGS. 5(a) to 5(c) and FIGS. 6(a) to 6(c), frequency is indicated logarithmically in the horizontal direction, and amplitude is indicated in the vertical direction. The correctable points are denoted f1 to f10. FIGS. 5(a) and 6(a) show the initial (uncorrected) transfer characteristics; FIGS. 5(b) and 6(b) show their inverse characteristics; FIGS. 5(c) and 6(c) show the corrected transfer characteristics.

FIGS. 5(a) to 5(c) show an example in which the peaks and dips coincide with correctable points, so that the correction is carried out in an approximately ideal form.

As shown in FIGS. 5(a) to 5(c), when the non-recursive digital filter means 5 performs a correction in an approximately ideal form, the inverse characteristic shown in FIG. 5(b) has a shape obtained by turning FIG. 5(a) upside down, and the corrected transfer characteristic becomes almost flat as shown in FIG. 5(c). With a small number of correctable points, however, it is difficult to recreate an inverse characteristic sufficiently faithful to steep changes in the characteristic such as the left peak at correctable point f2 and the dip at correctable point f5; it is usually not possible to cancel out all the peaks and dips. For parts that extend over several points, however, such as the right peak at correctable point f8, it is easy to derive a faithful inverse characteristic, and the corrected transfer characteristic becomes almost flat.

FIGS. 6(a) to 6(c) show an example in which the left peak and the dip are disposed at frequencies offset from the correctable points (such as f2 and f5), as shown in FIG. 6(a). The left peak and dip have to be corrected indirectly by making peak and dip corrections at nearby correctable points, but it is almost impossible to make a correction equivalent to the inverse characteristic of the peak shape. As a result, a correction equivalent to the rough shape of the characteristic is made at the nearby correctable points, as shown in FIG. 6(b), and the left peak and dip, which are offset from these correctable points, cannot be suppressed sufficiently, as shown in FIG. 6(c).

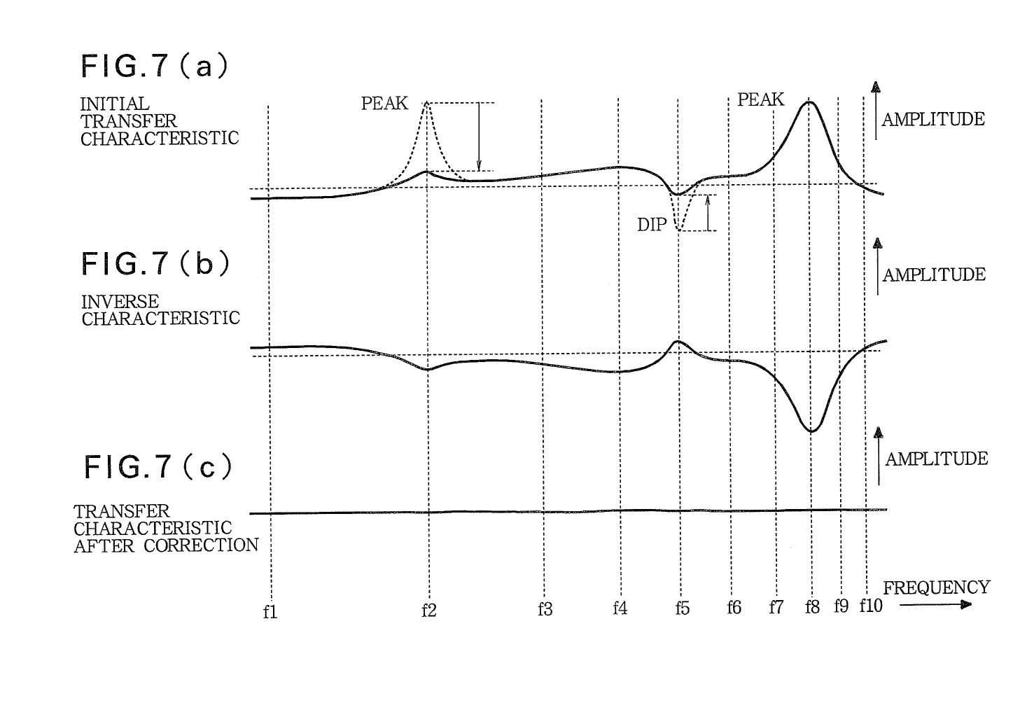

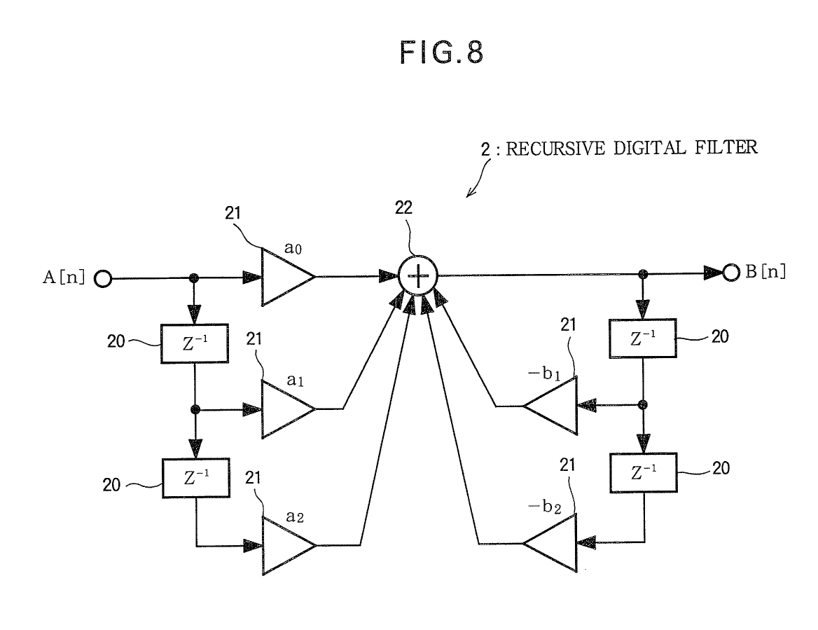

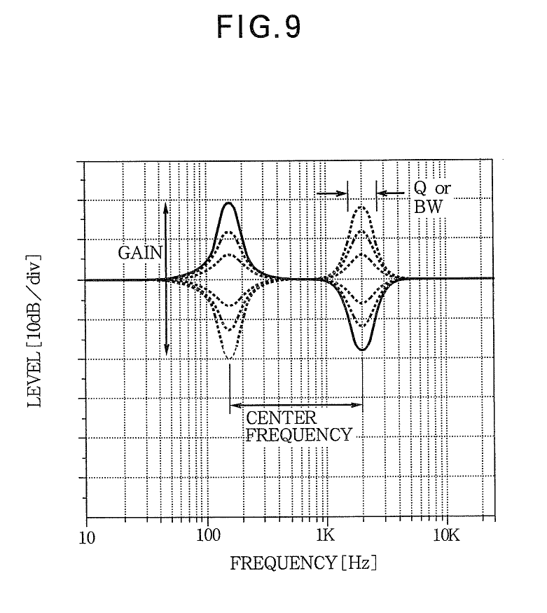

FIGS. 7(a) to 7(c) show an example in which the steep peaks and dips in the characteristic shown in FIGS. 5(a) to 5(c) are suppressed by the recursive digital filter means 2. The recursive digital filter means 2 uses a second-order IIR filter (biquad filter) structure formed by a group of delay units 20 which have a delay time of one sample period each and are connected as shown in FIG. 8, for example, a group of coefficient multipliers 21 for multiplying the undelayed signal and signals having different delays generated by the group of delay units 20 by coefficients a0, a1, a2, −b1, and −b2 respectively, and an adder 22 for adding the output values of the coefficient multipliers 21, and is implemented by providing certain coefficients representing a peaking filter characteristic as a0 to b2. A peaking filter forms peaks and dips at arbitrary frequencies in an amplitude characteristic, as shown in FIG. 9, for example, when given their center frequencies, gain values, and Q values (instead of the Q value, the peak sharpness or the peak width BW may be given); peaking filters are used as parametric equalizers in the acoustic signal field.

In this embodiment, the recursive digital filter means 2 has peaking filter coefficients for suppressing steep peaks and dips as shown in FIG. 7(a), with respect to the transfer characteristic from the speaker 10 to the listening position 13 in FIG. 1, that is, the transfer characteristic in FIG. 5(a). Accordingly, coefficients for implementing desired peaking filtering characteristics are supplied through the first correction coefficient input terminal 4 with reference to the characteristic in FIG. 5(a) and held in the first correction coefficient holding means 3, so that the peaks and dips are suppressed. Consequently, the recursive digital filter means 2 reads the coefficients from the first correction coefficient holding means 3 and suppresses the steep peaks and dips in advance as shown in FIG. 7(a), and a correction equivalent to the inverse characteristic of a characteristic including the characteristic of the recursive digital filter means 2 is made. It therefore becomes easier to implement the inverse characteristic in a more faithful form in parts having few correctable points (spaced at large intervals) as shown in FIG. 7(b), and easier to flatten the corrected transfer characteristic, as shown in FIG. 7(c), in comparison with the example shown in FIG. 5(c).

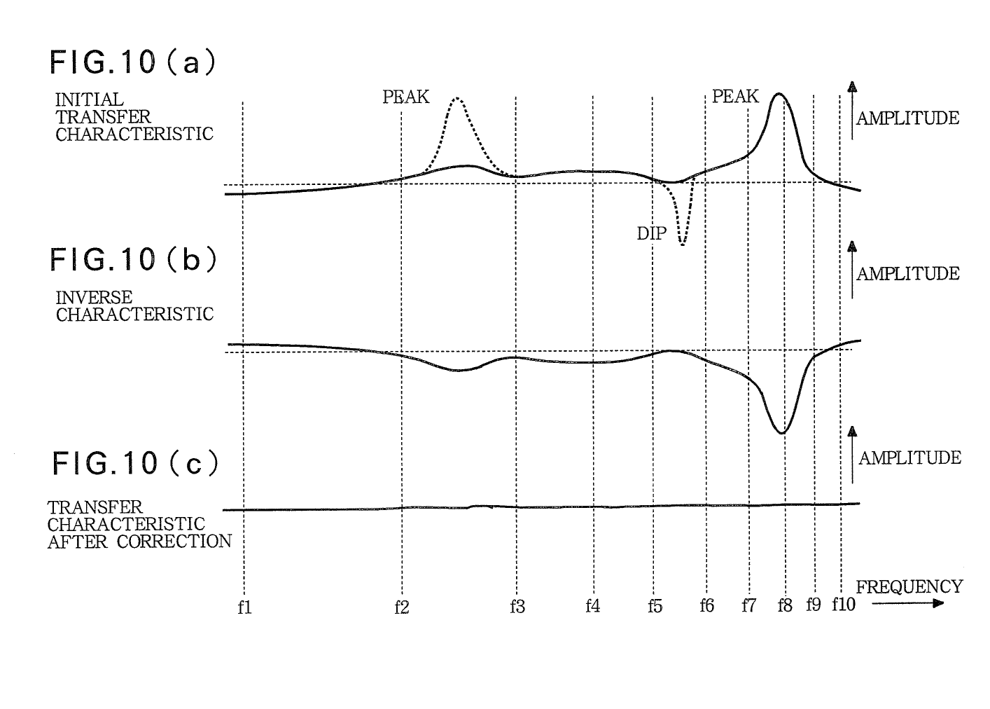

In cases in which peaks and dips appear at frequencies offset from correctable points as shown in FIG. 6(a), the peaks and dips can also be suppressed in advance by the recursive digital filter means 2, as shown in FIG. 10(a), making it easier to implement the inverse characteristic in a more faithful form, including parts having widely spaced correctable points, as shown in FIG. 10(b), and easier to flatten the corrected transfer characteristic as shown in FIG. 10(c), in comparison with the case illustrated in FIGS. 6(a) to 6(c).

Although cases in which the capability of correction by the inverse characteristic used by the non-recursive digital filter means 5 is improved by using the recursive digital filter means 2 have been described with reference to FIG. 1, a sufficient correction capability can be obtained in some structures without the recursive digital filter means 2.

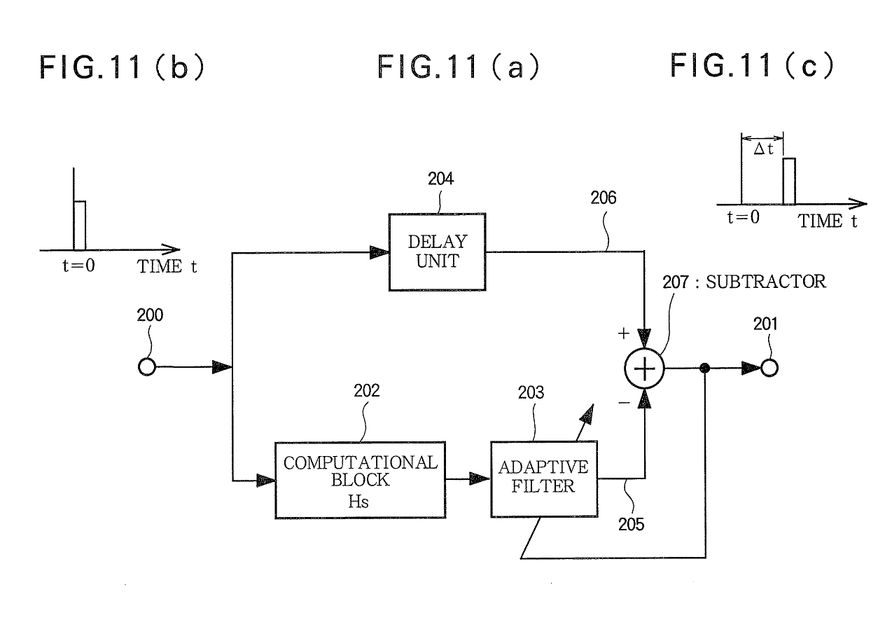

A method of deriving transfer function H0 (equivalent to the inverse characteristic of the combined frequency-amplitude characteristics from the speaker 10 to the listening position 13) in FIG. 1 will be described with reference to FIGS. 11(a) to 11(c).

In FIG. 11(a), suppose that when an impulse signal as shown in FIG. 11(b) is input as an audio input signal 200, the system outputs the same impulse signal as the input signal, delayed by a delay time of Δt added by a delay unit 204, as shown in FIG. 11(c). A characteristic such that the amplitude characteristic is constant over all frequencies and the group delay characteristic (linear phase characteristic with respect to frequency) is also constant is obtained for the output signal of the system. An acoustic characteristic with a constant amplitude characteristic, that is, with a flat sound pressure-frequency characteristic and a linear phase characteristic, is one of ideals of a speaker system; a method of implementing this characteristic with a non-recursive digital filter (FIR filter) will be described.

In FIG. 11(a), a subtractor 207 takes the difference between the output signal 206 of the delay unit 204 and the signal 205 obtained by sending the same audio input signal 200 as input to the delay unit 204 through a computational block 202 having the transfer function Hs of the speaker system, which is to be corrected (the target), and an adaptive filter 203 formed by a non-recursive digital filter (by applying transfer function Hs and the transfer function of the adaptive filter 203 to the audio input signal 200), and the coefficients of the adaptive filter 203 are adjusted to minimize the difference (error) between the two signals.

If the recursive digital filter means 2 is not inserted here, the transfer function Hs of the speaker system is set to a value equal to the transfer characteristic from the speaker 10 to the listening position 13.

The transfer characteristic of the adaptive filter 203 when the error 201 is minimized by the above adaptation process is obtained (identified) as the transfer function H0 having the inverse characteristic of the transfer function to be corrected. The coefficients of the adaptive filter 203 for implementing the transfer function H0 are determined at the same time.

The transfer function Hs of the speaker system to be corrected is obtained beforehand by experiment. More specifically, a microphone is placed at the listening position 13 shown in FIG. 1; the acoustic characteristic collected there is set as the transfer function Hs to be corrected; and the transfer function H0 having the inverse characteristic is identified in the adaptive filter 203 by use of the least mean squares (LMS) algorithm.

The transfer function H0a including the transfer characteristic of the recursive digital filter means 2 is obtained in the same way as the transfer function H0. In this case, the transfer function Hs of the speaker system is set to a value equal to a combined characteristic combining the transfer characteristic of the recursive digital filter means 2 and the transfer characteristic from the speaker 10 to the listening position 13.

In the above process, the computational block 202, adaptive filter 203, delay unit 204, and subtractor 207 can be implemented by software, that is, by a programmed computer system.

In the above signal adaptation process, instead of the least mean squares algorithm, any method or structure that can identify the inverse characteristic of the transfer function to be corrected can be selected.

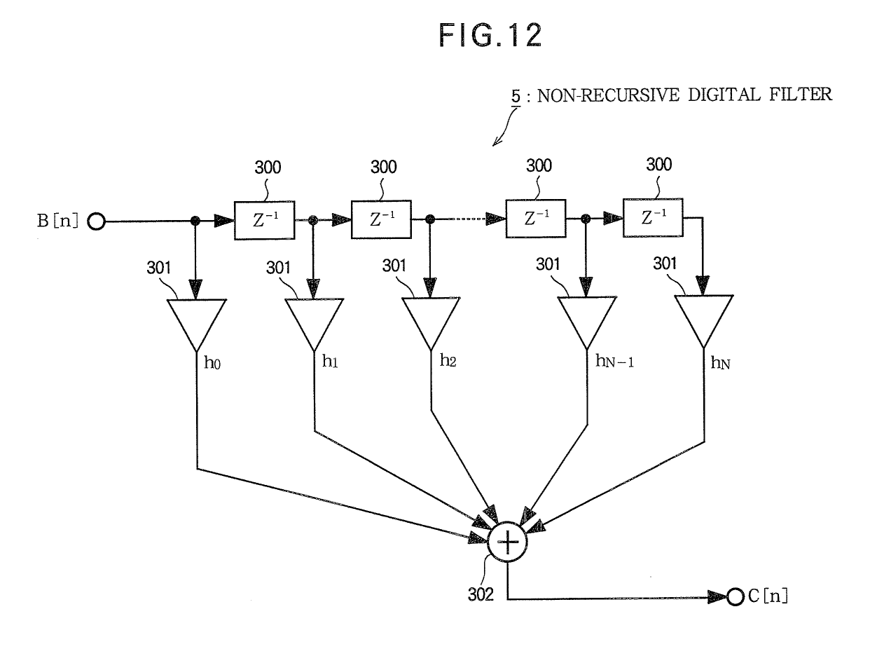

FIG. 12 is a block diagram illustrating the general type of FIR filter used as the non-recursive digital filter means 5.

The FIR filter includes a group of N delay units 300 which have a delay time of one sample period each and are connected in series, a group of coefficient multipliers 301 for multiplying the undelayed signal and signals having different delays generated by the group of delay units 300 by constants h0 to hN, and an adder 302 for adding the output values of the coefficient multipliers 301. The structure has a cascaded plurality of basic elements (taps) combining a delay unit 300 and a coefficient multiplier 301, the set finite number of taps being equivalent to the resolution of the characteristic correction in the frequency domain, which determines the number of correctable points.

The coefficients determined by the adaptive filter 203 in FIG. 11(a) are used as constants h, and the non-recursive digital filter means 5 shown in FIG. 1 uses these constants as correction coefficients when correcting the acoustic characteristic at the listening position 13 by performing a convolution operation with the inverse characteristic on the input audio signal.

In the transfer characteristic from the speaker 10 to the listening position 13 in FIG. 1, the appearance of the peaks and dips, such as their amplitudes, frequencies, and widths, may change with the volume level of the speaker 10 and the effects of reflection and absorption in the ambient environment. In order to enable adaptation to these changes in conditions, the first correction coefficient holding means 3 and second correction coefficient holding means 6 are used to hold a plurality of sets of correction coefficients, and the operating characteristics of the recursive digital filter means 2 and non-recursive digital filter means 5 are changed to suit the conditions.

The above process of determining correction coefficients is performed, for example, prior to shipment of the audio reproducing apparatus, and the results are stored in the second correction coefficient holding means 6 as sets of correction coefficients that produce arbitrary characteristics.

As described above, the second correction coefficient holding means 6 can store two or more sets of desired correction coefficients as sets of correction coefficients producing arbitrary characteristics.

A non-volatile memory, for example is used as the second correction coefficient holding means 6. Alternatively, the coefficients may be loaded into a volatile memory from, for example, the system microcontroller of the apparatus.

In the structure in FIG. 1, convolution of the inverse characteristic of the transfer characteristic from the speaker 10 to the listening position 13 onto the audio signal by the non-recursive digital filter means 5 changes the reproduction characteristic at the listening position 13 to an ideal flat frequency characteristic as shown in FIG. 4, and the output obtained from the input of the impulse signal in FIG. 11(b) becomes a single impulse when viewed on the time axis.

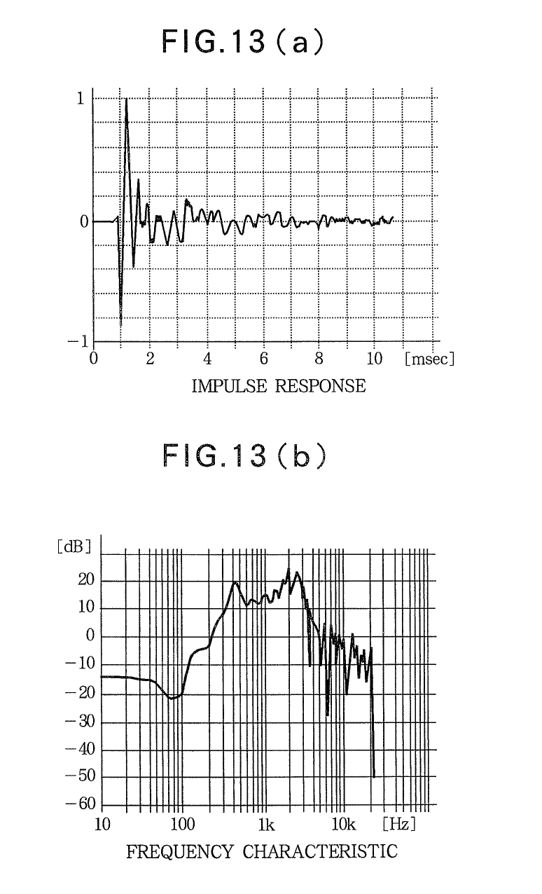

FIGS. 13(a) and 13(b), FIGS. 14(a) and 14(b), and FIGS. 15(a) and 15(b) show, by calculation, a correction process in which the inverse characteristic of an existing speaker with inadequate performance was obtained on the basis of the results of impulse response measurements, and convolved with the original acoustic signal.

FIG. 13(a) shows the uncorrected impulse response, and FIG. 13(b) shows the corresponding uncorrected frequency characteristic obtained by an FFT process, for a passband of about 300 Hz to 4 kHz.

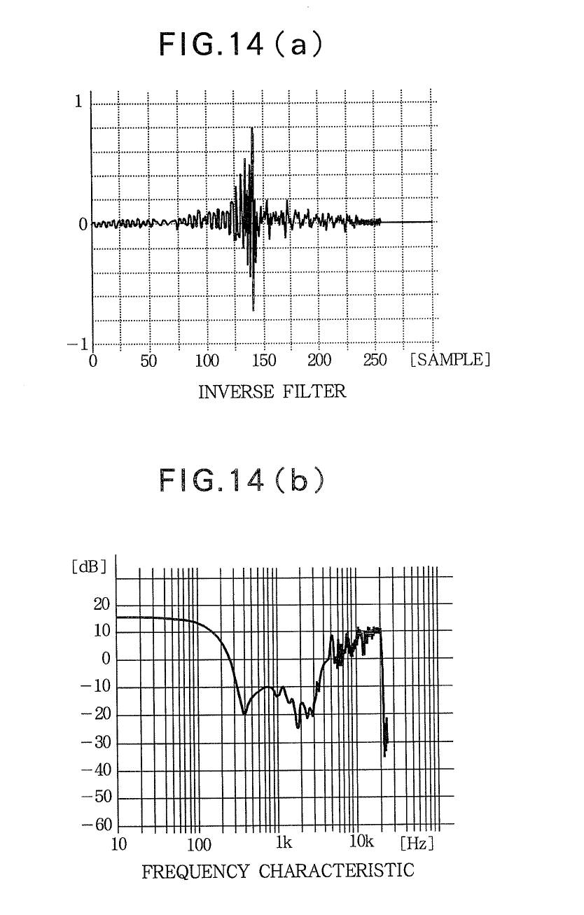

FIG. 14(a) shows the characteristic of the inverse characteristic filter, which is used to change the transfer characteristic, the horizontal axis representing time expressed in units of the sampling period.

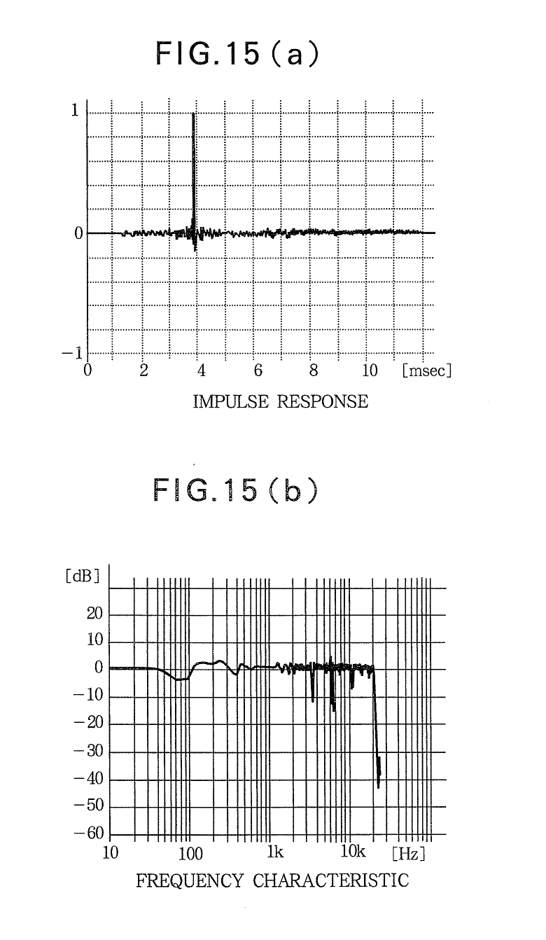

FIG. 14(b) shows the frequency characteristic (inverse characteristic) of the inverse characteristic filter; FIG. 15(a) shows the corrected impulse response; FIG. 15(b) shows the corresponding corrected frequency characteristic obtained by the FFT process.

The corrected impulse response was obtained by a convolution operation performed on the uncorrected impulse response and the inverse characteristic filter, whereby a single impulse was formed, and the frequency characteristic was flattened. As a result of the correction, an acoustic characteristic faithful to the input audio signal is obtained at the listening position 13.

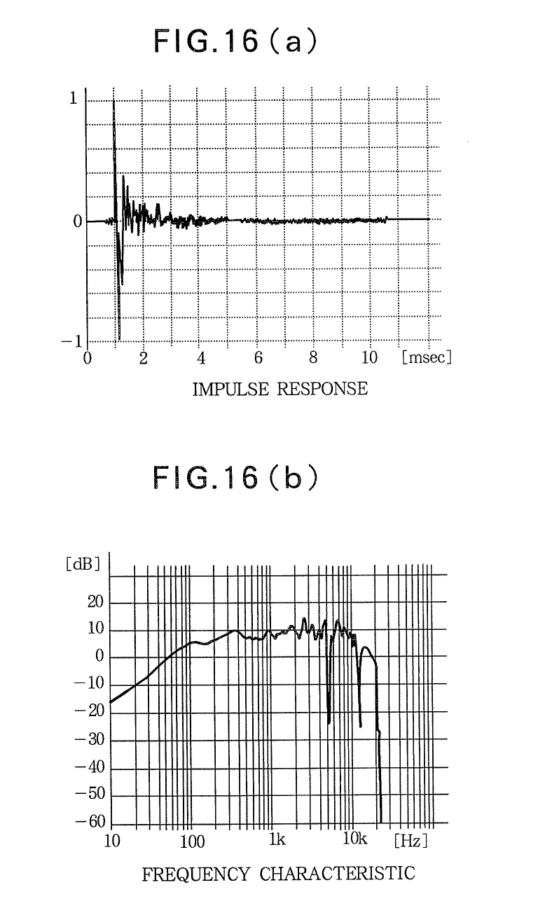

FIGS. 16(a) and 16(b) illustrate exemplary acoustic characteristics of a high sound quality speaker (a speaker generally considered to have high sound quality, thus a speaker having desired characteristics).

FIG. 16(a) shows the impulse response, and FIG. 16(b) shows the corresponding frequency characteristic obtained by the FFT process.

Inspection of the impulse response shows that the characteristic includes specific reverberation components rather than a single impulse. This reverberation characteristic expresses the lingering feel of the sound of the individual speaker, generates its unique sweetness, and improves the depth of its sound, so that a rich sound can be recreated. That is, it is true that a correction that produces a single impulse as shown in FIGS. 15(a) and 15(b) improves the fidelity to the audio signal input and can improve the sound quality in comparison with the uncorrected quality, but the improved sound quality is not equivalent to the sound quality of a so-called high sound quality speaker.

Reverberation characteristics generally refer to the time intensity of reverberant phenomena in which lingering sound generated by reflection is perceived in a listening environment after the sound source ceases acoustic radiation; such phenomena occur everywhere, in no small amounts. A room in which reverberation is reduced to the extreme limit, a so-called anechoic chamber, is a strongly disconcerting space because of its unusual reverberation characteristics. The time required to reduce the level of sound produced by reverberation by 60 dB relative to the level of sound produced directly from the sound source is referred to as the reverberation time.

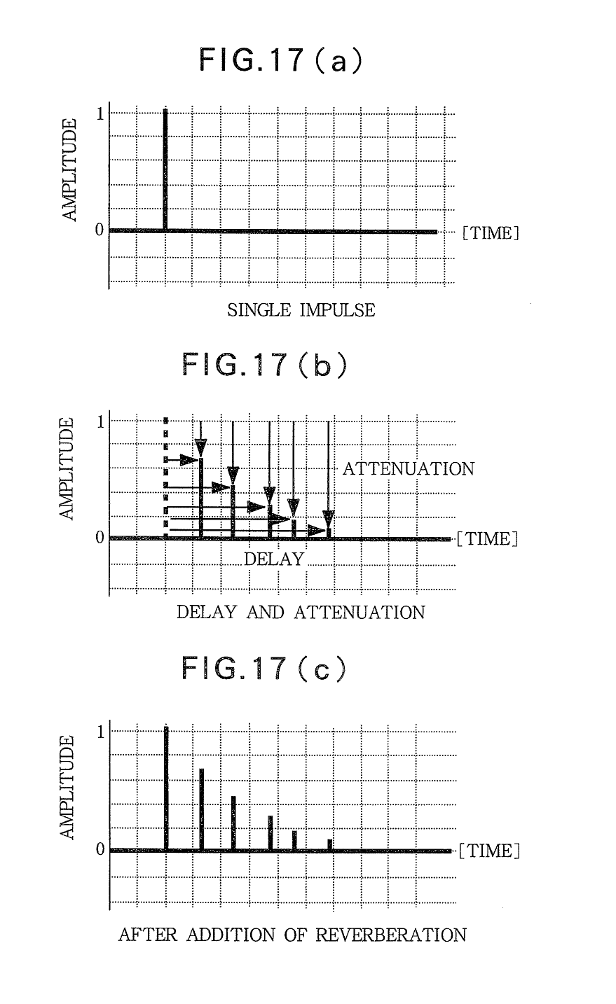

The reverberation characteristic appearing in the acoustic characteristics of the high sound quality speaker shown in FIGS. 16(a) and 16(b) is the result of measurements made in an anechoic chamber, so the reverberation is not derived from the structure of the room but is based on internal reflection by the constituent units of the speaker, its enclosure, and so on. If the transfer characteristic under consideration is a single impulse as shown in FIG. 17(a), for example, this type of reverberation characteristic can be simulated by applying a plurality of appropriate delays and amplitude attenuations as shown in FIG. 17(b) and combining the results to create a reverberation characteristic as shown in FIG. 17(c). These drawings show a conceptual characteristic, provided for explanatory purposes, which does not necessarily match any actual characteristic. In an actual reverberation characteristic, the reverberation time differs depending on the frequency; for example, a large hall has a shorter reverberation time at high frequencies than at low frequencies.

If a certain transfer characteristic is a single impulse as shown in FIG. 17(a), to add a reverberation characteristic as shown in FIG. 17(c), it suffices to convolve the two, so that the reverberation characteristic shown in FIG. 17(c) appears directly in the transfer characteristic. This is also true when the reverberation characteristic to be added is as shown in FIG. 16(a). For a single impulse, a reverberation characteristic or any characteristic can be added easily by performing a convolution operation.

It is not so easy, however, to add the reverberation characteristic of the high sound quality speaker shown in FIG. 16(a) to the inadequate-performance speaker having the transfer characteristic shown in FIG. 13(a). At least, this cannot be achieved just by performing a convolution operation on the two. However, since the corrected transfer characteristic shown in FIG. 15(a) is a single impulse, the reverberation characteristic of a high sound quality speaker can be added easily by convolution of the reverberation characteristic shown in FIG. 16(a) with respect to the corrected transfer characteristic shown in FIG. 15(a). The transfer characteristic in FIG. 15(a) is a result of convolution of the inverse correction filter in FIG. 14(a) on the audio signal by the non-recursive digital filter means 5 in FIG. 1; convolution of the reverberation characteristic in FIG. 16(a) is not performed directly on the transfer characteristic shown in FIG. 15(a).

This will be described with reference to FIG. 1. If an audio signal is reproduced by the structure shown in FIG. 1 with the transfer characteristic of the non-recursive digital filter means 5 changed by using the reverberation characteristic of the high sound quality speaker shown in FIG. 16(a) as the transfer characteristic of the computational block 400 having transfer function H00, using the inverse characteristic of the combined frequency amplitude characteristic from the speaker 10 to the listening position 13, i.e., the inverse correction filter characteristic in FIG. 14(a), as the transfer function H0, and storing the output of the convolver 401, which receives those inputs, in the second correction coefficient holding means 6, then the listening characteristic at the listening position 13 is not a single impulse as shown in FIG. 15(a); instead, the reverberation characteristic of the high sound quality speaker shown in FIG. 16(a) is recreated. That is, if the characteristic of a high sound quality speaker is desired, the characteristic of the high sound quality speaker can be realized by convolving its reverberation characteristic, storing the generated correction coefficients in the second correction coefficient holding means 6, and using them to perform a correction operation in the non-recursive digital filter means 5.

If a different target reverberation characteristic or any other characteristic is desired instead of the characteristic of a high sound quality speaker, it suffices to generate correction coefficients by convolution of the desired reverberation characteristic or the arbitrary (desired) characteristic and hold them in the second correction coefficient holding means 6.

A function obtained beforehand as described with reference to FIGS. 11(a) to 11(c) can be used as transfer function H0.

The transfer characteristic due to computational block 400 may be the reverberation characteristic of the high sound quality speaker shown in FIG. 16(a), the artificial reverberation characteristic shown in FIG. 17, or any characteristic that strengthens or attenuates a specific frequency band for a certain purpose. These are not limited to a single set; a mode of use is possible in which a plurality of target characteristics are obtained by selective use of a plurality of correction coefficients obtained by convolution with an inverse correction filter in the convolver 401 and held in the second correction coefficient holding means 6.

In the transfer characteristic of a transfer function H0 having an inverse correction filter characteristic, parts with a relatively large amplitude tend to be distributed to the right and left of the part with the maximum amplitude (before and after it on the time axis). A pattern beginning with a maximum amplitude part, followed by a tail of reverberation components, as shown in FIG. 16, for example, is taken by the computational block 400 having transfer function H00. Accordingly, in the convolver 401 in FIG. 1, the result of convolution of the transfer characteristic due to the computational block 400 having transfer function H00 with the transfer characteristic due to the transfer function H0 having an inverse correction filter characteristic is trimmed at the positions such that neither the characteristic of the inverse correction filter nor the reverberation characteristic is greatly lost, and stored in the second correction coefficient holding means 6. In general, the tap length of the non-recursive digital filter means cannot be extended amply with respect to the reverberation time because of constraints on delay length and circuit cost, so the number of correction coefficients held in the second correction coefficient holding means 6 is also constrained.

An effect of the present invention is that it can reliably recreate intended sound quality by convolution of an arbitrary transfer characteristic, in addition to high-fidelity audio reproduction based on correction by an inverse characteristic. Another effect is that a transfer characteristic desired by the designer or user can be implemented easily by superimposing an arbitrary transfer characteristic on a correction based on an inverse characteristic, so that they are combined together. A further effect is that the amount of delay generated in the non-recursive digital filter means can be greatly reduced by a configuration that, after combining the inverse-characteristic correction characteristic with the arbitrary transfer characteristic, uses them as correction coefficients.

### Second Embodiment

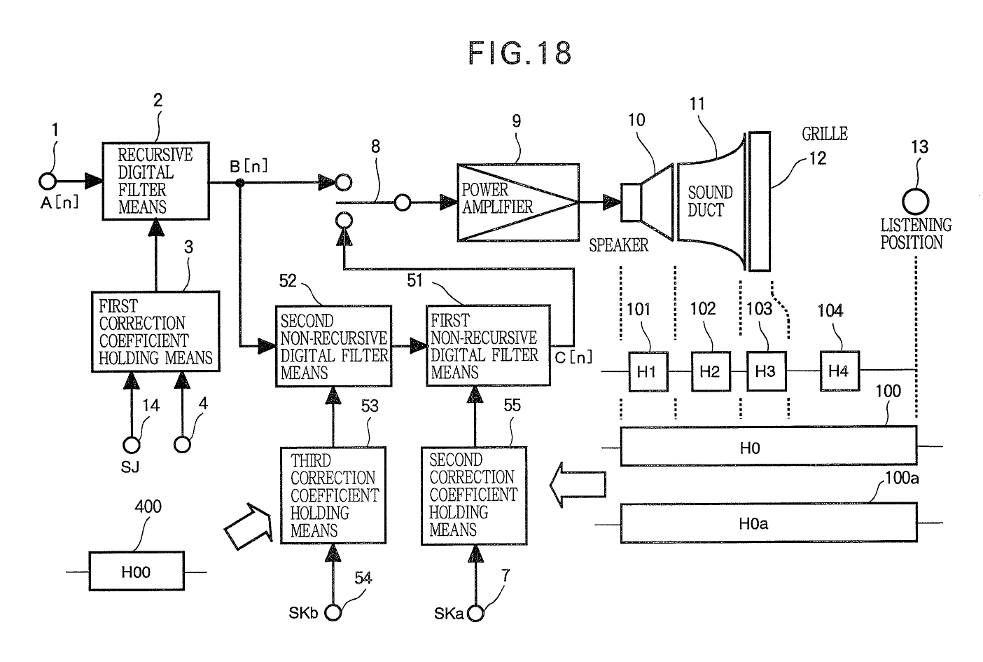

FIG. 18 is a block diagram illustrating the basic structure of an audio reproducing apparatus according to the second embodiment of the invention. The illustrated audio reproducing apparatus is generally the same as the audio reproducing apparatus in FIG. 1, but differs in the following respects: a first non-recursive digital filter means 51, a second non-recursive digital filter means 52, a third correction holding means 53, and a third correction terminal selection terminal 54 are provided in place of the non-recursive digital filter means 5 in the structure in FIG. 1; a second correction holding means 55 is provided in place of the second correction coefficient holding means 6; and the convolver 401 in FIG. 1 is not included. The first non-recursive digital filter means 51 and the second non-recursive digital filter means 52 are connected in cascade.

In FIG. 18, at least two sets of correction coefficients, based on the at least two characteristics of transfer function H0 and transfer function H0a, are held in the second correction holding means 55 and selected in accordance with a selection signal SKa input from the second correction coefficient selection terminal 7, to change the transfer characteristic of the audio signal in the first non-recursive digital filter means 51.

A plurality of sets of correction coefficients based on transfer functions H00 having arbitrary characteristics are held in the third correction holding means 53 and selected in accordance with a selection signal SKb input from the third correction terminal selection terminal 54, to change the transfer characteristic of the audio signal in the second non-recursive digital filter means 52.

In the structure in FIG. 18, the output B[n] of the recursive digital filter means 2 is input to the second non-recursive digital filter means 52, the output of which is input to the first non-recursive digital filter means 51 for processing, but the order of the first non-recursive digital filter means 51 and the second non-recursive digital filter means 52 may be reversed.

Both the first embodiment and the second embodiment eliminate the need for performing actual measurements or generating inverse characteristics in actual usage environments, so that a simplified circuit configuration and increased circuit size can be achieved.

In audio reproducing systems for various types of AV equipment, such as television sets, the present invention can be used to improve sound quality that has been degraded by increasingly adverse structural conditions on equipment due to miniaturization or reduced thickness, or under increasingly adverse acoustic performance conditions set due to cost reduction. It is also useful for adding an arbitrary reverberation characteristic to achieve high sound quality.

What is claimed is:

1. An audio reproducing apparatus that supplies an audio signal that has been corrected by a non-recursive digital filter means to a speaker means, thereby producing acoustic radiation, the audio reproducing apparatus comprising
a correction coefficient holding means for holding at least one set of correction coefficients based on an inverse characteristic of a transfer characteristic from the speaker means to a listening position, wherein:
the correction coefficients are calculated by convolution of an arbitrary transfer characteristic and the inverse characteristic; and
the correction coefficients held by the correction coefficient holding means are convolved with the audio signal in the non-recursive digital filter means to generate output.

2. An audio reproducing apparatus that supplies an audio signal that has been corrected by a non-recursive digital filter means and a recursive digital filter means to a speaker means, thereby producing acoustic radiation, the audio reproducing apparatus comprising
a correction coefficient holding means for holding at least one set of correction coefficients based on an inverse characteristic of a transfer characteristic from the speaker means to a listening position with an amplitude characteristic of the recursive digital filter means taken into account, wherein:
the correction coefficients are calculated by convolution of an arbitrary transfer characteristic and the inverse characteristic; and
the correction coefficients held by the correction coefficient holding means are convolved with the audio signal in the non-recursive digital filter means to generate output.

3. The audio reproducing apparatus of claim 2, wherein the recursive digital filter means has an amplitude characteristic that suppresses peaks and dips of the inverse characteristic of the transfer characteristic from the speaker means to the listening position.

4. The audio reproducing apparatus of claim 1, wherein a filter characteristic for enhancing or attenuating a specific frequency band of an acoustic characteristic of the output obtained by the convolution of the correction coefficients based on the inverse characteristic with the audio signal in the non-recursive digital filter means is used as the arbitrary transfer characteristic.

5. The audio reproducing apparatus of claim 1, wherein a desired reverberation characteristic is used as the arbitrary transfer characteristic.

6. The audio reproducing apparatus of claim 1, wherein a transfer characteristic of a speaker with a desired characteristic or a characteristic simulating the transfer characteristic of the speaker with the desired characteristic is used as the arbitrary transfer characteristic.

7. An audio reproducing apparatus that supplies an audio signal that has been corrected by a first and a second non-recursive digital filter means to a speaker means, thereby producing acoustic radiation, the audio reproducing apparatus comprising:
a first correction coefficient holding means for holding correction coefficients based on an inverse characteristic of a transfer characteristic from the speaker means to a listening position, for supply to the first non-recursive digital filter means; and
a second correction coefficient holding means for holding an arbitrary transfer characteristic for supply to the second non-recursive digital filter means; wherein
the correction coefficients held by the first and the second correction coefficient holding means are sequentially convolved with the audio signal in the first and second non-recursive digital filter means to generate output.

8. An audio reproducing apparatus that supplies an audio signal that has been corrected by a first and a second non-recursive digital filter means and a recursive digital filter means to a speaker means, thereby producing acoustic radiation, the audio reproducing apparatus comprising:
a first correction coefficient holding means for holding correction coefficients based on an inverse characteristic of a transfer characteristic from the speaker means to a listening position with an amplitude characteristic of the recursive digital filter means taken into account, for supply to the first non-recursive digital filter means; and
a second correction coefficient holding means for holding an arbitrary transfer characteristic for supply to the second non-recursive digital filter means, wherein:
the correction coefficients held by the first and the second correction coefficient holding means are sequentially convolved with the audio signal in the first and second non-recursive digital filter means to generate output.

9. The audio reproducing apparatus of claim 8, wherein the recursive digital filter means has an amplitude characteristic that suppresses peaks and dips of the inverse characteristic of the transfer characteristic from the speaker means to the listening position.

10. The audio reproducing apparatus of claim 7, wherein a filter characteristic for enhancing or attenuating a specific frequency band of an acoustic characteristic of the output obtained by the convolution of the correction coefficients based on the inverse characteristic with the audio signal in the first non-recursive digital filter means is used as the arbitrary transfer characteristic.

11. The audio reproducing apparatus of claim 7, wherein a desired reverberation characteristic is used as the arbitrary transfer characteristic.

12. The audio reproducing apparatus of claim 7, wherein a transfer characteristic of a speaker with a desired characteristic or a characteristic simulating the transfer characteristic of the speaker with the desired characteristic is used as the arbitrary transfer characteristic.

13. The audio reproducing apparatus of claim 2, wherein a filter characteristic for enhancing or attenuating a specific frequency band of an acoustic characteristic of the output obtained by the convolution of the correction coefficients based on the inverse characteristic with the audio signal in the non-recursive digital filter means is used as the arbitrary transfer characteristic.

14. The audio reproducing apparatus of claim 2, wherein a desired reverberation characteristic is used as the arbitrary transfer characteristic.

15. The audio reproducing apparatus of claim 2, wherein a transfer characteristic of a speaker with a desired characteristic or a characteristic simulating the transfer characteristic of the speaker with the desired characteristic is used as the arbitrary transfer characteristic.

16. The audio reproducing apparatus of claim 8, wherein a filter characteristic for enhancing or attenuating a specific frequency band of an acoustic characteristic of the output obtained by the convolution of the correction coefficients based on the inverse characteristic with the audio signal in the first non-recursive digital filter means is used as the arbitrary transfer characteristic.

17. The audio reproducing apparatus of claim 8, wherein a desired reverberation characteristic is used as the arbitrary transfer characteristic.

18. The audio reproducing apparatus of claim 8, wherein a transfer characteristic of a speaker with a desired characteristic or a characteristic simulating the transfer characteristic of the speaker with the desired characteristic is used as the arbitrary transfer characteristic.
